(19) United States
(12) Patent Application Publication
(10) Pub. No.: US 2008/0088868 A1
(43) Pub. Date: Apr. 17, 2008

(54) Multifunction device and image saving method

(75) Inventor: Takao Endo, Azumino-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/974,422

(22) Filed: Oct. 12, 2007

(30) Foreign Application Priority Data
Oct. 12, 2006 (JP) 2006-278462

(51) Int. Cl. G06F 3/12

(52) U.S. Cl. 358/1.13

(57) ABSTRACT

A multifunction device, comprising a facsimile receiving unit that receives a color image, a converting unit that converts color image data received by the facsimile receiving unit into monochrome image data, a comparing unit that compares file sizes of the color image data received by the facsimile receiving unit and the monochrome image data generated by the converting unit, and a storing unit that stores image data with a smaller file size determined from a comparison result from the comparing unit.

The present application claims priority under 35 U.S.C. § 119 to JP 2006-278462 filed on Oct. 12, 2006, which is hereby incorporated by reference in its entirety.

### BACKGROUND

1. Technical Field

The present invention relates to a method of saving an image file received by facsimile.

2. Related Art

As for a device for transmitting data using a telephone network, there is known a facsimile machine. The facsimile machine converts documents to electrical digital signals and transmits and receives the converted digital signals to and from a selected facsimile machine of which address is a facsimile number.

JP-A-1993-063998 discloses an image transmission technique using a facsimile machine, in which, upon transmitting monochrome documents, sizes of color encoded data and monochrome encoded data are compared with each other and image data with a smaller size, of the color encoded data and the monochrome encoded data, is transmitted in order to shorten facsimile transmission time. The above-mentioned patent document also discloses a technique in which, of the color encoded data and the monochrome encoded data, the one which matches with the characteristics of the selected facsimile machine is sent.

The above-mentioned patent document discloses image transmission processing using a facsimile machine but does not mention image reception processing using a facsimile machine at all.

As a kind of facsimile machine, a multifunction device has been known. A known multifunction device has a function of saving a received image as a file in a shared folder in order to use the received image as log data as well as a function of printing the received image after facsimile reception. Such a multifunction device is structured in a manner such that a color image is saved in the shared folder in the case of received a color image and a monochrome image is saved in the shared folder in the case of received a monochrome image.

However, since users at a facsimile receiver use the saved images as only log data, most of the users are satisfied with monochrome images as images to be saved. Further, even in the case in which the multifunction device allows the received log image to be displayed on a display panel thereof, the display panel is practically a monochrome display unit in many multifunction devices and thus the display panel can not respond to color images. As described above, in the case of using a file saving function in a facsimile machine or a multifunction device, it is practically considered that there is no need to save color images received by facsimile and it is sufficient to save and use monochrome images corresponding to the received color images. In addition, in the case in which the images received by facsimile are saved in the shared folder, there is a limit in file saving area and thus it is difficult to save a large number of files.

There is also another type of multifunction device having a function of generating an e-mail to which an image file received by facsimile is attached and sending the e-mail with the attached file to a predetermined destination. The known multifunction device having such function is structured in a manner such that it sends an e-mail to which a color image file is attached in the case of received a color image and sends an e-mail to which a monochrome image file is attached in the case of received a monochrome image. However, it is desired to decrease the load of a mail server by reducing size of a file attached to a mail to the minimum.

### SUMMARY

An advantage of some aspects of at least one embodiment of the invention is that it provides a multifunction device which can save a color image in a data format having a smaller file size in a shared folder or send it with a mail at the time of received the color image by facsimile.

In the present application specification, the term “unit” or “portion” not only includes physical unit but also include software which implements functions of the unit or the portion. A function of one unit or portion may be performed by two or more physical units. Alternatively, functions of two or more units or portions may be performed by one physical unit.

### BRIEF DESCRIPTION OF THE DRAWINGS

The invention will be described with reference to the accompanying drawings, wherein like numbers reference like elements.

FIG. 1 is a block diagram illustrating a schematic structure of an information processing system.

FIG. 2 is a block diagram illustrating functions of a CPU 14.

FIG. 3 is a view illustrating an exemplary menu used to set output destination, facsimile receiving condition, or the like.

FIG. 4 is a flow chart illustrating the flow of processing in a multifunction device 10.

FIG. 5 is a view illustrating a flow chart illustrating the flow of image conversion processing to monochrome TIFF.

FIG. 6 is view illustrating an exemplary hierarchy of a shared folder which saves an image file.

FIG. 7 is a view illustrating an exemplary comparison result of file sizes.

### DESCRIPTION OF EXEMPLARY EMBODIMENTS

Hereinafter, embodiments of the invention will be described with reference to the accompanying drawings. Like numbers reference like elements in the drawings, and repetitive explanation will be omitted.

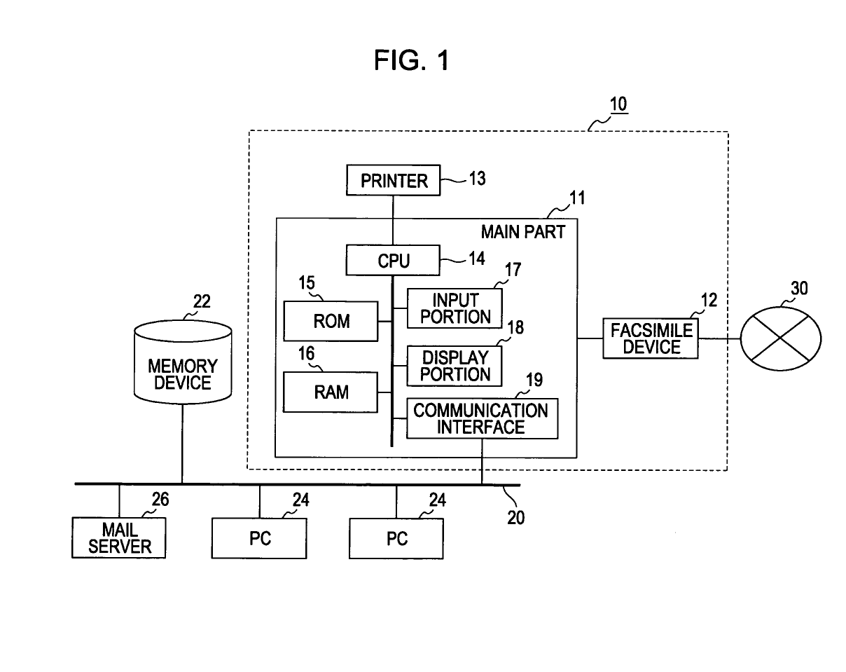

FIG. 1 shows a schematic structure of an information processing system according to one embodiment. As shown in FIG. 1, the information processing system includes a multifunction device 10 having a facsimile transmitting and receiving function. The information processing system is connected to a network 20 and a public network 30. A memory device 22 is connected to the network 20 and is used as a shared folder. A personal computer (PC) 24 and a mail server 26 are connected to the network 20.

The multifunction device 10 is generally an integrated image forming device to which functions of a scanner, a storage device, and a facsimile device are added. However, the multifunction device 10 in this invention is a device including at least main part 11 for controlling operations of the multifunction device 10 and a facsimile device (facsimile receiver) 12 having a function of transmitting and receiving data by a facsimile technique through the public network 30. The multifunction device 10 optionally includes a printer (image forming device) 13 which prints images according to circumstances.

The main part 11 includes a control processing unit (CPU) 14, a read only memory (ROM) 15, a random access memory (RAM) 16, an input portion 17, and a display portion 18, and a communication interface 19. The CPU 14 functions as a control portion and an operational device and generally controls all devices and circuits of the multifunction device 10. The ROM 15 stores a program. The RAM 16 functions as a temporary memory for data and an operation area of the CPU 14 when the program is executed by the CPU 14.

The input portion 17 is an element which allows a user to input instruction commands. For example, the input portion 17 can be an input key. The display portion 18 is an element to display messages or the like from the multifunction device 10. The display portion is, for example, a liquid crystal display panel. The input portion 17 and the display portion 18 may be a liquid crystal display touch panel. The communication interface 19 is connected to the network 20 and controls transmission and reception of data.

The network 20 includes a local area network (LAN), a company-wide network, a private network, an Internet, a packet communication network, a telephone network, other communication networks, and combinations thereof. The network 20 also may be a wired network or a wireless network.

The memory device 22 is connected to the network 20 and is used as a shared folder. In this embodiment, the memory device 22 stores facsimile image data received by the facsimile device 12 and image data generated by converting or processing the received facsimile image data.

The mail server 26 is connected to the network 20 and an external network such as Internet. The mail server 26 can be a server computer which enables clients (multifunction device 10, PC 24, or the like) connected to the network 20 to perform mail-sending and mail-receiving. For example, The mail server 26 includes a simple mail transfer protocol (SMTP) server for sending e-mails and a post office protocol (POP) server for delivering e-mails to users. A fire wall server may be optionally interconnected between the mail server 26 and the external network.

The public network 30 is a circuit network enabling facsimile transmission and reception. For example, the public network 30 includes a telephone line, an Internet, a LAN, a private network, a packet communication network, a company-wide network, other communication lines, a combination thereof. The public network 30 may be a wired network or a wireless network.

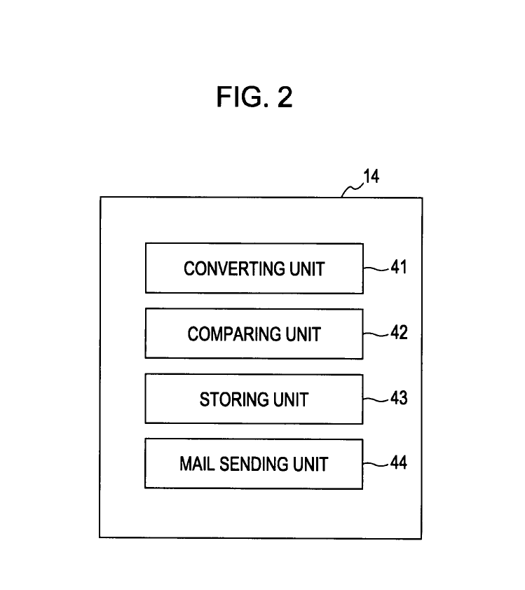

FIG. 2 shows function blocks of the CPU 14 according to this embodiment. As shown in FIG. 2, the CPU 14 functions as a converting unit 41, a comparing unit 42, a storing unit 43, and a mail sending unit 44. In this embodiment, the multifunction device 10 performs its functions in a manner such that the CPU 14 executes a predetermined program stored in the ROM 15.

The converting unit 41 functions to convert color image data received by the facsimile device 12 to monochrome (black and white) image data. At this time, the monochrome image data generated by image conversion processing may be in any image format, but be preferably in monochrome TIFF (halftone processing/MMR compression) for the convenience's sake of data management. Further, it is preferable that the received color image data is in JPEG format.

The comparing unit 42 compares file sizes of the color image data received by the facsimile device 12 and the monochrome image data generated by the converting unit 41 and determines which image file of the color image data and the monochrome image data is smaller in file size. For example, the comparing unit 42 compares the color JPEG-format file received by the facsimile device 12 and the monochrome TIFF file generated by converting the received JPEG-format file and determines which file is smaller in size.

The storing unit 43 selects image data having a smaller size on the basis of the comparison result from the comparing unit 42, of the received image data and the converted image data, and saves and stores the selected image data into a shared folder of the memory device 22. At this time, it is preferable that a file saving destination is preset. The saved image data is named any file name as long as it can clearly specify the saved image data. For example, it is preferable that a facsimile reception date and time can be used as the file name.

The mail sending unit 44 sends an e-mail to which image data with a smaller file size determined on the basis of the comparison result from the comparing unit 42 is attached to a predetermined facsimile machine. In greater detail, the generated e-mail is first sent to the mail server 26 and then delivered to the destination facsimile. At this time, it is preferable that the transmission facsimile of the e-mail is preset.

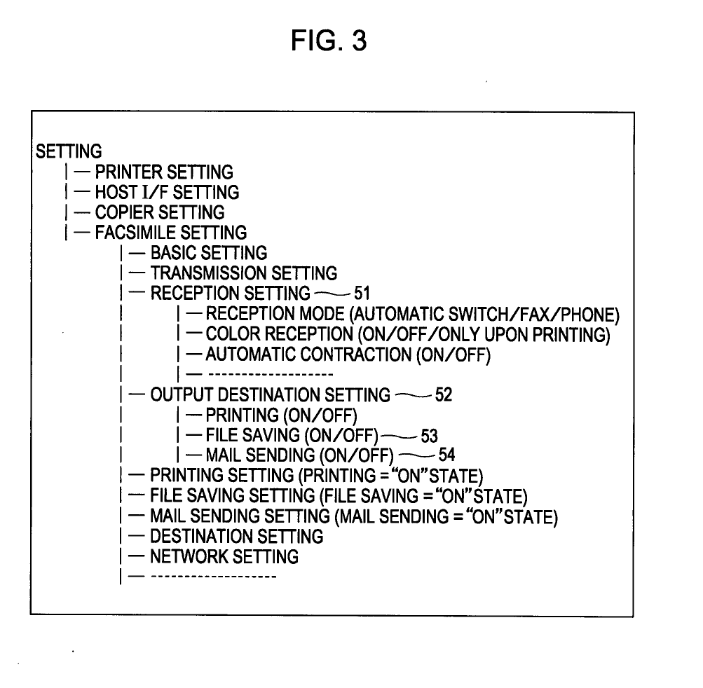

FIG. 3 shows the hierarchy of the menu used for setting output destination and receiving conditions of a facsimile in the multifunction device 10. As shown in FIG. 3, the multifunction device 10 allows various operation conditions to be set. In a reception setting layer 51, receiving conditions in the facsimile device 12 are set. In an output destination setting layer 52, it is possible to set an output destination of the received image data.

By setting items 53 in relation to file saving in the output destination setting layer 52, it is possible to select saving (ON) or no-saving (OFF) of the received image data or the converted image data generated by performing predetermined image conversion processing with respect to the received image data to the shared folder of the memory device 22.

By setting items 54 in relation to mail sending in the output destination setting layer 52, it is possible to select sending (ON) or no-sending (OFF) of the received image data or the converted image data generated by performing predetermined image conversion processing with respect to the received image data. If the sending (ON) is selected, an e-mail to which the received image data or the converted image data generated by performing predetermined image conversion processing with respect to the facsimile received image data is attached is sent.

In this embodiment, the setting item 53 in relation with the file saving is set to “ON” and a file saving mode in which image data is saved in the shared folder after facsimile reception is selected. In this embodiment, a menu screen with the menu hierarchy shown in FIG. 3 is displayed on the display panel 18 of the multifunction device 10 or a display unit of the PC 24, and a user can set the output destination and facsimile receiving condition by manipulating the menu screen.

Hereinafter, operations of the multifunction device 10 having the above-mentioned structure will be described.

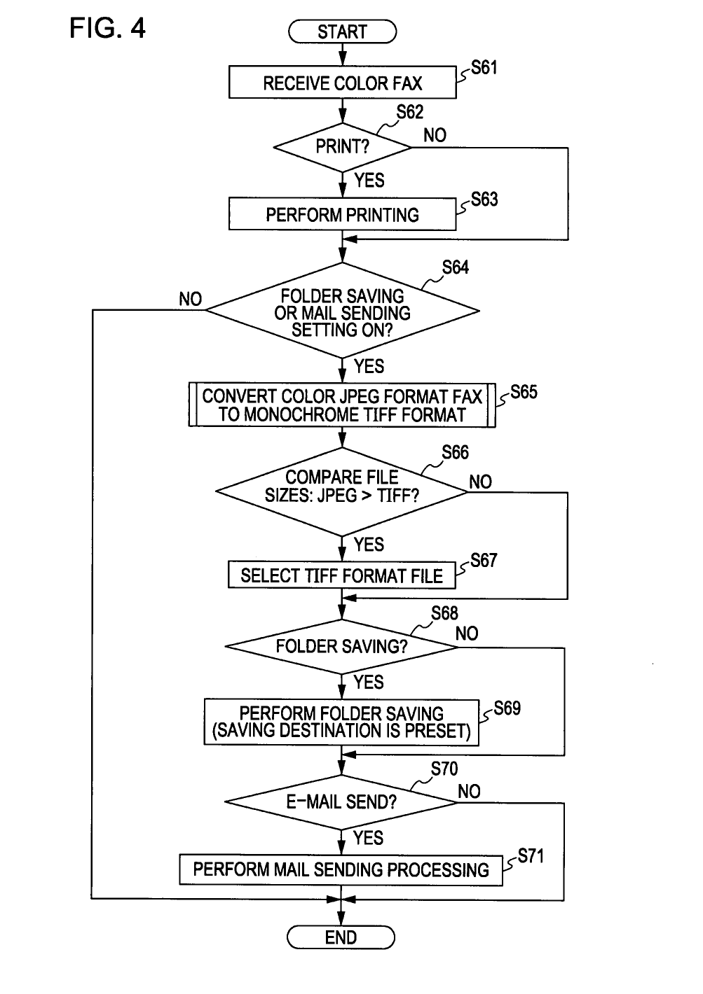

FIG. 4 is a flow chart showing processing flow of the multifunction device 10 according to this embodiment. The multifunction device 10 determines whether to print a received facsimile image (S62) on the basis of the output destination setting 52 which is preset when the facsimile device 12 receives a facsimile color image (S61). At this time, in the case in which the output destination setting 52 is made so as to print the received facsimile image (S62: YES), the received facsimile image is printed using the printer 13 (S63). At this time, a printed image format may be different from the format of the received facsimile image. On the other hand, in the case in which the output destination setting 52 is made so as not to print the received facsimile image (S62: NO), printing is not performed and a subsequent process is performed.

Next, it is determined whether the output destination setting 52 is made so as to perform file saving or mail sending (S64). In the case in which the output destination setting 52 is made so as to perform neither the file saving nor the mail sending (S64: NO), the operation processing is finished. Conversely, the output destination setting 52 is made so as to perform either the file saving or the mail transmission (S64: YES), the operation processing continues.

Upon performing either the file saving or the mail sending, the multifunction device 10 converts the received color JPEG-format image to monochrome TIFF image (S65). Details of such image conversion processing will be described later. Next, the multifunction device 10 compares file sizes of the received color JPEG-format image and the monochrome TIFF image and determines which image of the color JPEG-format image and the monochrome TIFF image is smaller in file size (S66). In the case in which the monochrome TIFF image has a smaller file size than the color JPEG-format image (S66: YES), the monochrome TIFF image is selected as an object to be saved as a file or to be sent with a mail (S67). Conversely, in the case in which the color JPEG-format image has a smaller file size than the monochrome TIFF image (S66: NO), the color JPEG-format image is saved or sent with a mail (S68).

After the image format to be saved or sent with a mail is selected, it is determined whether the output destination setting 52 is made so as to perform the file saving or not (S68). In the case in which the output destination setting 52 is made so as to perform the file saving (S68: YES), the selected image, i.e. the image with a smaller file size, is saved and stored in the shared folder of the memory device 22 (S69). In the case in which the output destination setting 52 is made so as not to perform the file saving (S68: NO), step S70 is performed. Further, it is preferable that the file saving destination is preset using the display panel 18 of the multifunction device 10 or the PC 24.

Next, it is determined whether the output destination setting 52 is made so as to perform the mail sending or not (S70). In the case in which the output destination setting 52 is made so as to perform the mail sending (S70: YES), a mail to which the selected image, i.e. the image with a smaller file size is attached is produced and sent to the mail server 26, so that mail sending is achieved (S71). In the case in which the output destination setting 52 is made so as not to perform the mail sending (S70: NO), the operation processing of the multifunction device 10 is finished. Further, it is preferable that the mail sending destination is preset using the display panel 18 of the multifunction device 10 or the PC 24.

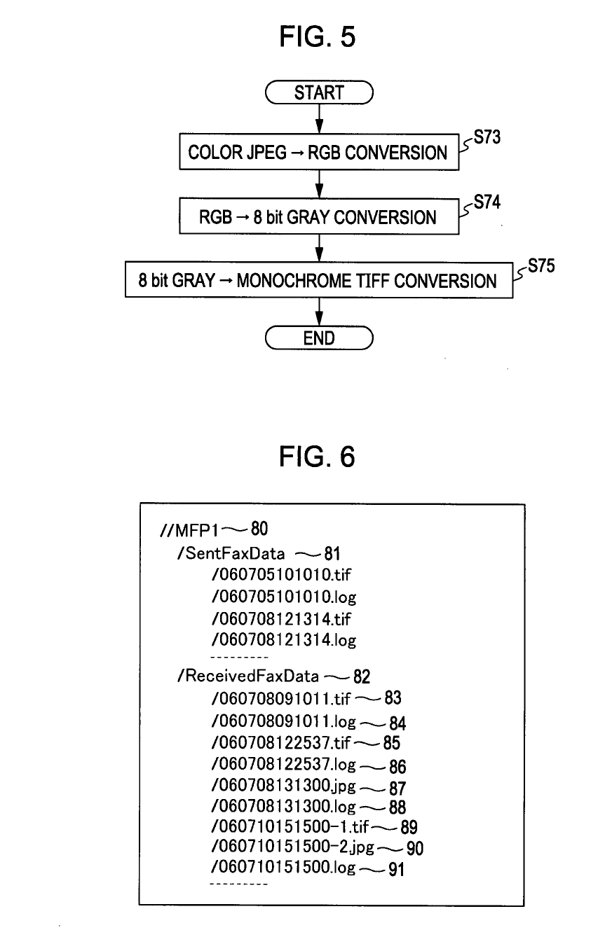

FIG. 5 is a flow chart illustrating flow of image conversion processing from color JPEG-format image to monochrome TIFF image in step S65.

First, a color JPEG-format image received by the facsimile device 12 is converted to an RGB image (S73). The RGB image is converted to an 8-bit gray image (S74). The conversion to the 8-bit gray image is performed based on the following Expression 1.

Y=0.3R+0.59G+0.11B(0≦Y,R,G,B≦255) (Expression 1)

Subsequently, the 8-bit gray image is converted to a monochrome TIFF image (halftone processing/MMR compression) (S75). Thus, the color JPEG-format image received by facsimile is converted to the monochrome TIFF image.

FIG. 6 shows the hierarchy of the shared folder in which the image file is saved. The example shown in FIG. 6 relates to the case in which a temporal saving destination is set to “\\MFP1” folder 80, so that in the case in which the output destination setting 52 is made so as to perform the file saving, the images transmitted or received by facsimile are saved in the “MFP1” folder 80. That is, images transmitted by the facsimile device 12 in the multifunction device 10 are saved in “\SentFaxData” folder 81 which is an under layer folder of the “\\MFP1” folder 80, and images received by the facsimile device 12 in the multifunction device 10 are saved in “\ReceivedFaxData” folder 82 which is another under layer folder of the “\\MFP1” folder 80. The image transmitted and received by the facsimile device 12 is saved in the form of a set of an image file and a log file. At this time, it is preferable that the file names of the saved images are automatically generated using the facsimile transmission or reception data and time.

In the example of the “\ReceivedFaxData” folder 82 shown in FIG. 6, files 83, 85, 87, 89, and 90 represent image files and files 84, 96, 88, and 91 represent log files. Each log file includes a variety of information, such as reception protocol, paper size, number of pages, date and time. Each set of files 83 and 84, 85 and 86, 87 and 88, and 89 and 91 is a cluster of received images. The files 83 and 85 are saved in TIFF (monochrome image) generated by image conversion processing, and the file 87 is saved in JPEG format (color image) as received.

The files 89 and 90 represent an image composed of two pages. The first page of the image (file 89) is saved in monochrome TIFF and the second page (file 90) is saved in color JPEG format. In this manner, in the case of transmitting and receiving an image composed of a plurality of pages by facsimile, file size comparison between the color JPEG-format image and the monochrome TIFF image generated by image conversion processing is performed page by page, image selection and saving for selecting and saving an image with a smaller file size are also performed by page by page. Instead of generating a plurality of image files separated from each other page by page from a single image, a multi-page-type single image file composed of a plurality of pages may be generated.

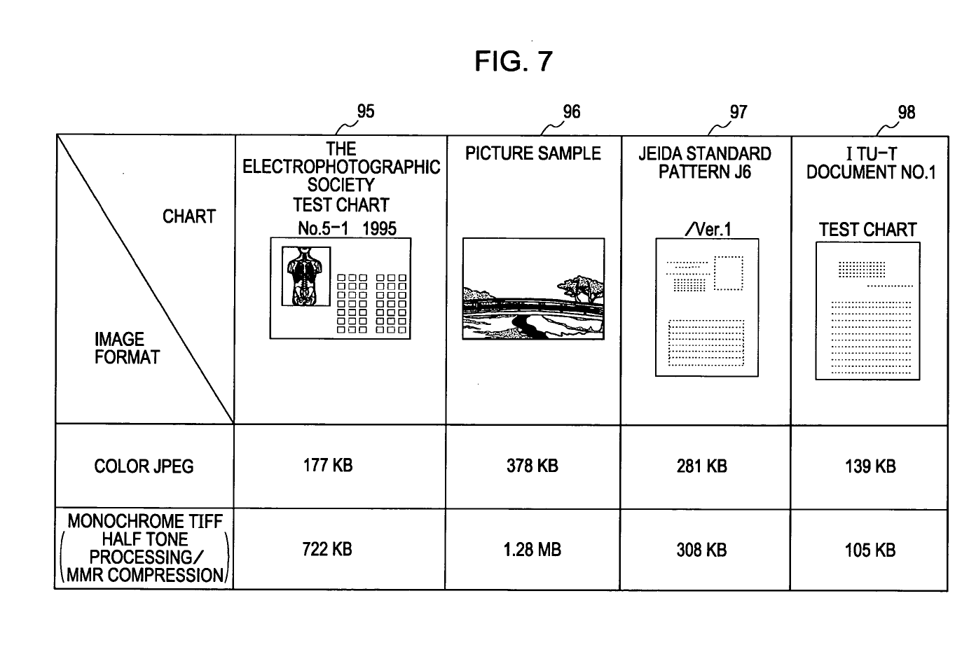

FIG. 7 shows a comparison example of color JPEG-format images and monochrome TIFF images in the cases in which the materials (documents) are different types. As shown in FIG. 7, for documents such as the electrophotographic society test chart number 5-1 (1995) 95 shown in FIG. 5, the file size of the color JPEG-format image received by facsimile is 177 KB and the file size of the monochrome TIFF image generated by image conversion processing (halftone processing/MMR compression) is 722 KB. Accordingly, according to the invention, the test chart 95 is saved or sent with an e-mail in color JPEG format. As shown in FIG. 7, for a document such as a picture sample 96 and the Japan Electronic Industry Development Association (JEIDA) standard pattern J6 (ver. 1) 97, the color JPEG-format images are smaller than the monochrome TIFF images in file size. Accordingly, the images 96 and 97 are also saved or sent with an e-mail in color JPEG-format. Conversely, a document such as the ITU-T document number 1 test chart 98 has a file size of 139 KB when it is a color JPEG-format image and a file size of 105 KB when it is a monochrome TIFF image. Accordingly, the image 98 is saved or sent with an e-mail in monochrome TIFF.

As described above, according to the invention, file sizes of a color JPEG-format image and a monochrome TIFF image generated by image conversion processing of the color JPEG-format image received by facsimile are compared, the image with a smaller file size can be saved or sent with an e-mail. In this manner, since it is possible to suppress the size of files to be saved, it is possible to effectively use memory area. Further, in the case of sending an e-mail with the image, since it is possible to suppress the size of a file to be attached to an e-mail, it is possible to decrease load of a mail server. Further, It is possible to suppress communication cost and communication traffic.

The invention may not limited to the above-described embodiments, but be implemented in various forms in the scope of the invention as long as it is apart from the spirit of the invention. Accordingly, it is apparently understood that the above-described embodiments are shown only on the purposes of examples but not be construed to limit the invention. For example, processing steps described above may be performed in different order or simultaneously as long as the change of order does not contradict a goal to be achieved by the processing.

What is claimed is:

1. A multifunction device, comprising:
a facsimile receiving unit that receives a color image;
a converting unit that converts color image data received by the facsimile receiving unit into monochrome image data;
a comparing unit that compares file sizes of the color image data received by the facsimile receiving unit and the monochrome image data generated by the converting unit; and
a storing unit that stores image data with a smaller file size determined from a comparison result from the comparing unit.

2. The multifunction device according to claim 1, comprising an e-mail sending unit for sending an e-mail to which image data with a smaller file size is attached instead of comprising the storing unit.

3. The multifunction device according to claim 1, wherein the color image data is in color JPEG format.

4. The multifunction device according to claim 1, wherein the monochrome image data is in monochrome TIFF format.

5. An image saving method for use in a multifunction device comprising:
receiving by facsimile a color image data;
converting the color image data received by the facsimile device to monochrome image data;
comparing file sizes of the color image data and the monochrome image data converted from the color image data; and
storing image data with a smaller file size determined from said comparing.

6. A program executed in a computer which controls a multifunction device in order to implement the image saving method according to claim 5.

7. A multifunction device, comprising:
a facsimile that receives a color image;
a converter that converts color image data received by the facsimile receiving unit into monochrome image data;
a comparator that compares file sizes of the color image data received by the facsimile and the monochrome image data generated by the converter; and
a memory that stores image data with a smaller file size determined from a comparison result from the comparator.
